(19) United States
(12) Patent Application Publication
(10) Pub. No.: US 2025/0370897 A1
(43) Pub. Date: Dec. 4, 2025

(54) FREQUENCY CONTROL METHOD AND SYSTEM FOR NEURAL PROCESSING UNIT

(71) Applicant: Samsung Electronics Co., Ltd., Suwon-si (KR)

(72) Inventors: Kyungmok KUM, Suwon-si (KR); Nahyun KIM, Suwon-si (KR); Buyoung YUN, Suwon-si (KR)

(73) Assignee: Samsung Electronics Co., Ltd., Suwon-si (KR)

(21) Appl. No.: 19/078,809

(22) Filed: Mar. 13, 2025

(30) Foreign Application Priority Data
May 30, 2024 (KR) 10-2024-0070726
Sep. 12, 2024 (KR) 10-2024-0124697

(51) Int. Cl. G06F 11/34; G06N 3/045; G06N 3/063

(52) U.S. Cl. CPC G06F 11/3447; G06N 3/045; G06N 3/063

(57) ABSTRACT

A frequency control method for a neural processing unit according to at least one embodiment includes receiving information about a neural network model to be executed on a neural processing unit (NPU), extracting static feature data determined within offline time of the neural network model and dynamic feature data determined within runtime of the neural network model from information about the NPU and information about the neural network model, generating a prediction model for predicting operating frequency of the NPU for executing the neural network model based on the static feature data and the dynamic feature data, and controlling the operating frequency of the NPU based on the prediction model.

### CROSS-REFERENCE TO RELATED APPLICATIONS

This application claims priority to and the benefit of Korean Patent Application No. 10-2024-0070726 filed at the Korean Intellectual Property Office on May 30, 2024, and Korean Patent Application No. 10-2024-0124697 filed at the Korean Intellectual Property Office on Sep. 12, 2024, the entire contents of which are incorporated herein by reference.

### BACKGROUND

### (a) Field

The present disclosure relates to a frequency control method and system for a neural processing unit (NPU).

### (b) Description of the Related Art

On-device NPUs for smartphones are becoming commercially available, and NPUs play a key role in performing artificial intelligence (AI)-based tasks (such as image recognition and voice recognition) more quickly and efficiently. Such high performance requires high power consumption, which is a major issue in battery-based smartphones.

Therefore, when a neural network model (NN model) is executed on an NPU to meet the user's needs, improving power efficiency as well as performance is beneficial for overcoming such issues, and which is being addressed through dynamic voltage frequency scaling (DVFS).

However, existing NPU DVFS technology uses a method of correcting and predicting the operating frequency of the next NPU based only on the operating frequency information of the NPU for previously executed neural network models. The above method predicts the operating frequency of the NPU based only on past information without considering the characteristics of each of a plurality of neural network models executed on the NPU and the correlation or characteristics between the NPU hardware system, so it is difficult to predict the frequency accurately, resulting in unnecessary power loss.

### SUMMARY

At least one embodiment relates to a frequency control method and system for a neural processing unit capable of minimizing power consumption while satisfying a target execution time of a neural network model.

A frequency control method for a neural processing unit (NPU) according to at least one embodiment for solving the technical object includes receiving information about a neural network model to be executed on the NPU, extracting static feature data determined within offline time of the neural network model and dynamic feature data determined within runtime of the neural network model from information about the NPU and information about the neural network model, generating a prediction model based on the static feature data and the dynamic feature data such that the prediction model is configured to predict an operating frequency of the NPU executing the neural network model, and controlling the operating frequency of the NPU based on the prediction model.

A frequency control method for a neural processing unit (NPU) according to at least one embodiment includes storing information about a neural network model to be executed on the NPU, extracting static feature data determined within offline time of the neural network model and dynamic feature data determined within runtime of the neural network model from the information about the neural network model, predicting a magnitude of an operating frequency and a setting point of the operating frequency for executing the neural network model by constructing a function based on the static feature data and the dynamic feature data, the function represented by a scaling factor, and updating a value of the scaling factor based on a result of the execution of the neural network model.

A frequency control system for a neural processing unit (NPU) according to at least one embodiment includes an NPU controller, an NPU MAC operator configured to perform multiply-accumulate (MAC) operation on a neural network model, a memory configured to receive and buffer information about the neural network model, an NPU direct memory access (NPU DMA) configured to control input/output of information about the neural network model between the NPU controller and the memory, and a system bus configured to support communication between the NPU controller and the memory, wherein the NPU controller is configured to store information about the neural network model, extract static feature data determined within offline time of the neural network model and dynamic feature data determined within runtime of the neural network model from the information about the neural network model, predict a magnitude of an operating frequency and a setting point of the operating frequency for executing the neural network model by constructing a function based on the static feature data and the dynamic feature data, the function represented by a scaling factor, and update a value of the scaling factor based on a result of the execution of the neural network model.

### BRIEF DESCRIPTION OF THE DRAWINGS

FIG. 1 illustrates a hierarchical structure of a frequency control system for a neural processing unit according to at least one embodiment of the present disclosure.

FIG. 2 illustrates an NPU DVFS governor module according to at least one embodiment of the present disclosure shown in FIG. 1.

FIG. 3 illustrates a model manager module according to at least one embodiment of the present disclosure shown in FIG. 2.

FIG. 4 illustrates a feature extractor module and static feature data according to at least one embodiment of the present disclosure shown in FIG. 2.

FIG. 5 illustrates a feature extractor module and dynamic feature data according to at least one embodiment of the present disclosure shown in FIG. 2.

FIG. 6 illustrates a workload prediction module according to at least one embodiment of the present disclosure shown in FIG. 2.

FIG. 7 illustrates a model updater module according to at least one embodiment of the present disclosure shown in FIG. 2.

FIG. 8 is a flowchart illustrating a frequency control method for the neural processing unit according to at least one embodiment of the present disclosure.

FIG. 9 is a flowchart illustrating a pre-processing operation of a neural network model of the frequency control method for the neural processing unit according to at least one embodiment of the present disclosure shown in FIG. 8.

FIG. 10 is a flowchart illustrating a post-processing operation of a neural network model of the frequency control method for the neural processing unit according to at least one embodiment of the present disclosure shown in FIG. 8.

FIG. 11 illustrates a mobile device to which a frequency control system for the neural processing unit according to at least one embodiment of the present disclosure is applied.

### DETAILED DESCRIPTION OF THE EMBODIMENTS

In the following detailed description, only certain embodiments of the present invention are shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive, and like reference numerals designate like elements throughout the specification. In the flowchart described with reference to drawings in this description, the operation order may be changed, several operations may be merged, certain operations may be divided, and specific operations may not be performed. In addition, the terms “unit”, “model”, “module”, “processor”, and/or other terms describing a functional element configured to perform certain roles used herein may be implemented and/or supported by processing circuitry such as, hardware, software, or a combination of hardware and software unless. For example, the processing circuitry may include, but is not limited to, a central processing unit (CPU), an application processor (AP), an arithmetic logic unit (ALU), a graphic processing unit (GPU), a digital signal processor, a microcomputer, a field programmable gate array (FPGA), a System-on-Chip (SoC) a programmable logic unit, a microprocessor, or an application-specific integrated circuit (ASIC), etc., unless expressly indicated otherwise. Additionally, any or all of the elements described with reference to the figures may communicate with any or all other elements described with reference to figures. For example, any element may engage in one-way and/or two-way and/or broadcast communication with any or all other elements in the figures, to transfer and/or exchange and/or receive information such as but not limited to data and/or commands, in a manner such as in a serial and/or parallel manner, via a bus such as a wireless and/or a wired bus. The information may be in encoded various formats, such as in an analog format and/or in a digital format.

In addition, expressions described in the singular may be interpreted as singular or plural unless an explicit expression such as “one” or “single” is used. While terms including ordinal numbers, such as “first” and “second,” etc., may be used to describe various components, such components are not limited to the above terms. These terms are only used to distinguish one constituent element from another constituent element.

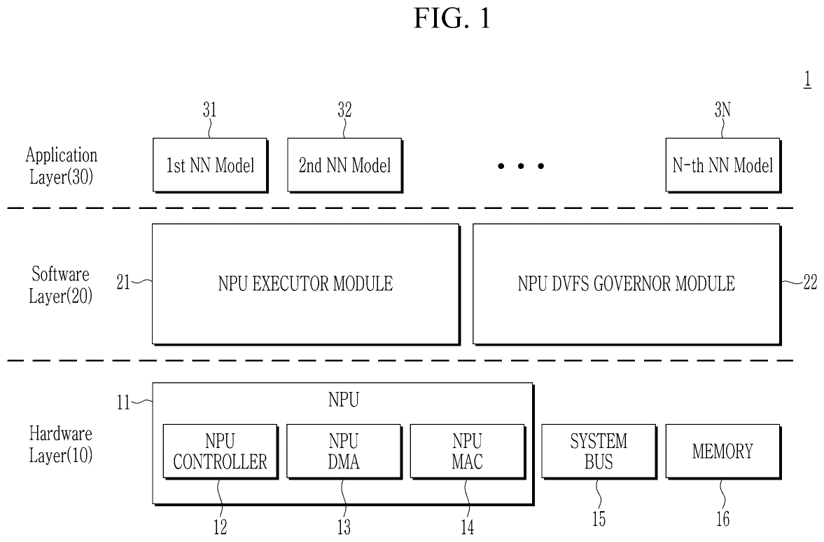

Hereinafter, the present disclosure will be described in more detail through embodiments. These examples are merely for illustrating the present disclosure, and the scope of rights protection of the present disclosure is not limited by these examples. FIG. 1 illustrates a hierarchical structure of a frequency control system for a neural processing unit according to at least one embodiment of the present disclosure.

A frequency control system for a neural processing unit 1 may have a hierarchical structure including a hardware layer 10, a software layer 20, and an application layer 30.

The hardware layer 10 is the lowest layer of the frequency control system for the neural processing unit 1, and may include hardware devices such as an NPU 11, a system bus 15, and a memory 16. The NPU 11 may include an NPU controller 12, an NPU direct memory access (DMA) 13, an NPU multiply-accumulate (MAC) operator 14.

The NPU controller 12 may be configured to drive an NPU executor module 21 and an NPU DVFS governor module 22. The NPU controller 12 may be configured to control the operation of the NPU DMA 13, the NPU MAC operator 14, the system bus 15, and the memory 16 by driving the NPU executor module 21 and the NPU DVFS governor module 22, and may control the operating frequency of each hardware device.

The NPU MAC operator 14 may be configured to perform MAC operations on neural network models 31 to 3N based on the control of the NPU controller 12. Specifically, the NPU MAC operator 14 may perform an MAC operation on the neural network models 31 to 3N based on the operating frequency set by the NPU controller 12.

The memory 16 may be configured to receive and buffer information about the neural network models 31 to 3N to be executed on the NPU 11. In some embodiments, the memory 16 may be a dynamic random-access memory (DRAM), although the embodiments are not necessarily limited thereto.

The NPU DMA 13 may be configured to control and/or assist in the input/output of information about the neural network models 31 to 3N between the NPU controller 12 and the memory 16. Specifically, the NPU DMA 13 and the memory 16 may transmit information about the neural network models 31 to 3N to be executed in the NPU 11 to each other based on the operating frequency set by the NPU controller 12.

The system bus 15 may be configured to support communication between the NPU 11 and the memory 16. Specifically, the system bus 15 may support communication between the NPU 11 and the memory 16 based on the operating frequency set by the NPU controller 12.

Meanwhile, in FIG. 1, only the NPU 11 including the NPU controller 12, the NPU DMA 13, and the NPU MAC operator 14 in the hardware layer 10, and the system bus 15 and the memory 16 are illustrated, but the embodiments are not necessarily limited thereto, and the hardware layer 10 may include any other configuration configured to execute the neural network models 31 to 3N.

For ease of description, the NPU controller 12, NPU DMA 13, NPU MAC operator 14, system bus 15, and memory 16 included in the hardware layer 10 are each referred to as a hardware device.

The software layer 20 may include the NPU executor module 21 and the NPU DVFS governor module 22. The NPU executor module 21 and the NPU DVFS governor module 22 may be driven by the NPU controller 12 of the hardware layer 10. However, the embodiments are not necessarily limited thereto, and the NPU executor module 21 and the NPU DVFS governor module 22 of the software layer 20 may be performed by an external host device such as a CPU.

The NPU executor module 21 is driven by the NPU controller 12, and may receive a request for execution of the neural network models 31 to 3N from a user and/or from a host device (e.g., CPU), and may operate a hardware device included in the hardware layer 10 to execute the neural network models 31 to 3N. The NPU executor module 21 may request the NPU DVFS governor module 22 to control the operating frequency of the hardware device included in the hardware layer 10 when executing the neural network models 31 to 3N by the hardware layer 10. The NPU executor module 21 may transmit the execution result to a user (e.g., CPU) when the execution of the neural network models 31 to 3N is terminated.

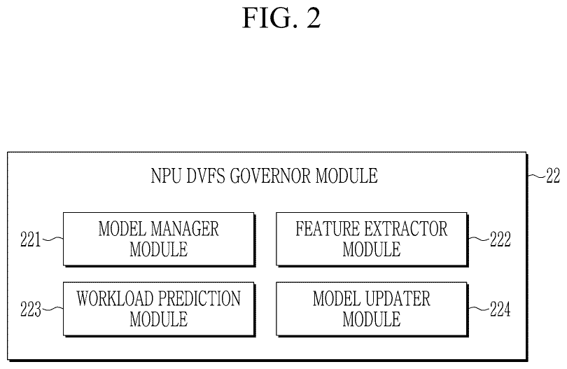

When the NPU DVFS governor module 22 receives a DVFS request for devices of the hardware layer 10 from the NPU executor module 21, the NPU DVFS governor module 22 may be driven by the NPU controller 12 to control the operating frequency of devices of the hardware layer 10. The NPU DVFS governor module 22 may control the operating frequency of devices included in the hardware layer 10 by executing closed loop control. Specific details are described below in FIG. 2.

The application layer 30 may be executed on the software layer 20 and may include a plurality of neural network models 31 to 3N. For example, when the frequency control system for the neural processing unit 1 is included in a mobile device such as a smart phone, the application layer 30 may include an application for driving a camera, and the plurality of neural network models 31 to 3N may include a model for detecting an object included in an image frame acquired by a camera application, a model for identifying what the detected object is, a model for detecting a target region in the image frame, a model for identifying the detected target region, or a model for classifying the identified target regions according to meaning (such as a person, a car, or a tree, etc.). However, the types of neural network models 31 to 3N are not limited thereto.

According to at least one embodiment of the present disclosure, the software layer 20 may control the operating frequencies of the devices of the hardware layer 10 for executing the plurality of neural network models 31 to 3N based on information about each of the plurality of neural network models 31 to 3N and information about the devices of the hardware layer 10.

FIG. 2 illustrates an NPU DVFS governor module according to at least one embodiment of the present disclosure shown in FIG. 1.

Referring to FIG. 2, the NPU DVFS governor module 22 may include a model manager module 221, a feature extractor module 222, a workload prediction module 223, and a model updater module 224.

As described with respect to FIG. 1, the model manager module 221, the feature extractor module 222, the workload prediction module 223, and the model updater module 224 may be driven by the NPU controller (12 of FIG. 1), and the following will be described from the perspective of the operations or functions performed by each module driven by the NPU controller (12 of FIG. 1).

The model manager module 221 may manage information on neural network models requested for execution. Specifically, when an execution request for a specific neural network model is received from a user and/or host device (e.g., CPU), the model manager module 221 may receive and store static information and dynamic information about the corresponding neural network model. Static information may include information that is dependent on the neural network model, such as an amount of MAC computation to be employed to execute the neural network. Dynamic information may include information related to the corresponding execution of a neural network model, such as a model execution request period of a corresponding neural network model.

The feature extractor module 222 is configured to extract feature data relevant to learning a relationship between the characteristics of the neural network model and the hardware devices included in the hardware layer. For example, the feature extractor module 222 may extract static feature data determined within the offline time of the neural network model from static information about the neural network model and information about the hardware device included in the hardware layer. Additionally, the feature extractor module 222 may extract dynamic feature data determined within the runtime of the neural network model from dynamic information about the neural network model and information about the hardware device included in the hardware layer.

The workload prediction module 223 is configured to create a prediction model that predicts the operating frequency of a hardware device for executing a neural network model based on extracted static feature data and dynamic feature data. The prediction model may be created by constructing a function represented by a scaling factor with static feature data and dynamic feature data.

The workload prediction module 223 may be configured to predict the magnitude of the operating frequency and the setting point of the operating frequency based on the prediction model. The workload prediction module 223 may control the operating frequency of the hardware device by setting the predicted operating frequency as the setting point of the operating frequency. Thereby, the efficiency of the hardware device may be increased by allocating a higher operating frequency when a higher operating frequency is predicted and allocating a lower operating frequency when a lower operating frequency is predicted.

In addition, when a plurality of neural network models is executed, the workload prediction module 223 may update dynamic feature data regarding the remaining neural network models requested for execution when the execution of a specific neural network model is terminated. For example, when the execution of the first neural network model is terminated, the workload prediction module 223 may update dynamic feature data regarding a second neural network model that is executed subsequent to a first neural network model.

The model updater module 224 may be configured to analyze the execution result of the neural network model and to update a prediction model function of the workload prediction module 223 based on the execution result of the neural network model. For example, the model updater module 224 may be configured to initiate an update of the prediction model when the accuracy of the prediction model is below a tolerance level.

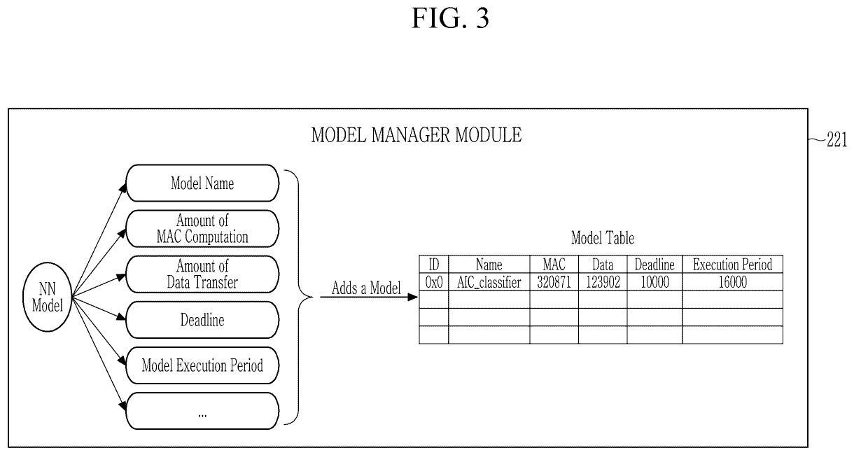

FIG. 3 illustrates a model manager module according to at least one embodiment of the present disclosure shown in FIG. 2.

Referring to FIG. 3, the model manager module 221 may load the neural network model requested for execution and information about the corresponding neural network model. The model manager module 221 may store information about the neural network model in the form of a table.

For example, information about a neural network model may include static information such as an ID of the corresponding neural network model, the amount of MAC computation required to execute the corresponding neural network model, the amount of data required to execute the corresponding neural network model, and dynamic information such as an execution deadline of the neural network model and an execution request period of the corresponding neural network model.

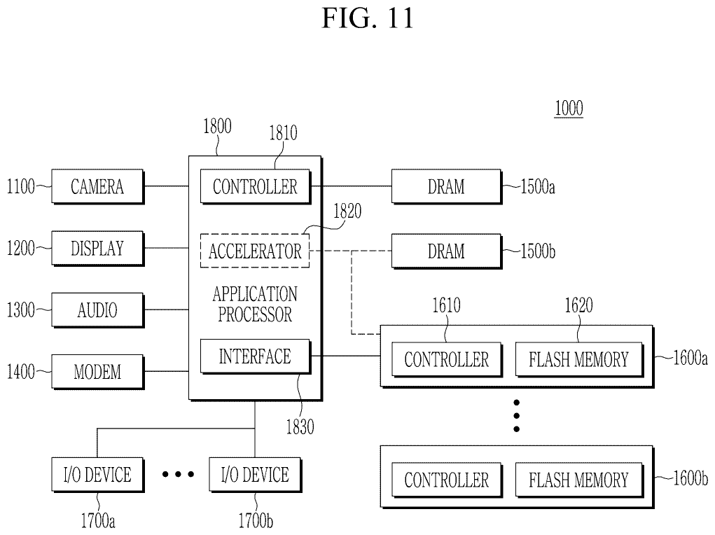

When a plurality of neural network models is requested to be executed, the model manager module 221 may store static information and dynamic information about each neural network model in the same table. Information about a plurality of neural network models stored in a table may be maintained in the table until the frequency control system (1 in FIG. 1) receives a termination command from a user and/or host device (e.g., CPU). Specifically, when the frequency control system (1 of FIG. 1) is included in a mobile device (1000 of FIG. 11), information about a plurality of neural network models stored in the table may be maintained in the table until the execution of the mobile device (1000 of FIG. 11) is terminated.

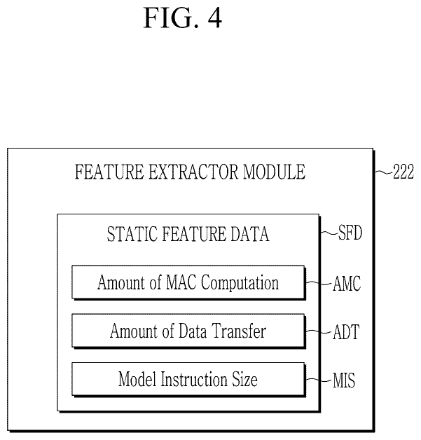

FIG. 4 illustrates a feature extractor module and static feature data according to at least one embodiment of the present disclosure shown in FIG. 2.

Referring to FIG. 4, the feature extractor module 222 may extract a static feature data SFD from static information about the neural network model and information of the hardware device as described with respect to FIG. 2.

The static feature data SFD may refer to data that is extracted based on static information about the neural network model and information about the hardware device, without being affected by the current execution environment of the hardware device. In other words, the static feature data SFD may be determined and extracted within the offline time of the neural network model.

The static feature data SFD may include data such as an amount of MAC computation AMC of the NPU MAC operator (14 in FIG. 1) required to execute the corresponding neural network model, the amount of data transfer ADT from the memory (16 in FIG. 1) through the NPU DMA (13 in FIG. 1) to execute the corresponding neural network model, and a model instruction size MIS of the corresponding neural network. The static feature data SFD for the corresponding neural network model may be stored in a table by the model manager module (211 in FIG. 2).

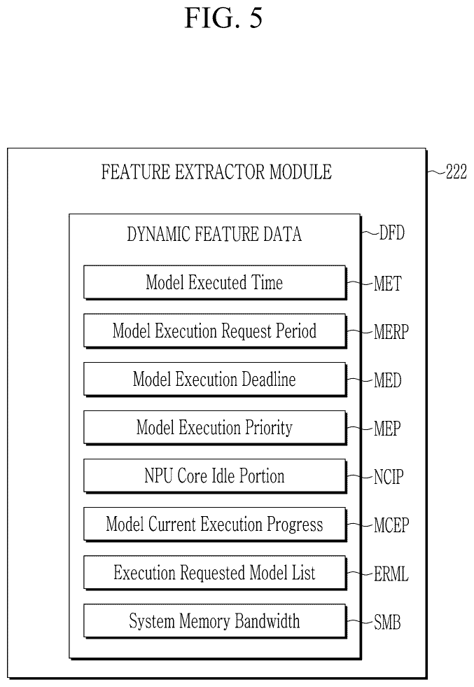

FIG. 5 illustrates a feature extractor module and dynamic feature data according to at least one embodiment of the present disclosure shown in FIG. 2.

Referring to FIG. 5, the feature extractor module 222 may extract dynamic feature data DFD from dynamic information about the neural network model and information about the hardware device as described with respect to FIG. 2.

The dynamic feature data DFD may refer to data that changes depending on the real-time execution environment of a hardware device. In at least some embodiments, the dynamic feature data DFD may be determined and extracted within the runtime of the neural network model.

The dynamic feature data DFD may include data such as a model executed time MET of the corresponding neural network, a model execution request period MERP of the corresponding neural network, a model execution deadline MED of the corresponding neural network, a model execution priority MEP of the corresponding neural network, an NPU core idle portion NCIP during execution of the corresponding neural network model, a model current execution progress MCEP of the corresponding neural network, an execution requested model list ERML of the neural network if a plurality of neural network models are requested for execution, a system memory bandwidth SMB used for execution of the neural network model, and/or the like. The dynamic feature data DFD for the corresponding neural network model may be stored in a table by the model manager module (211 in FIG. 2).

Although only specific static feature data SFD and dynamic feature data DFD are illustrated in FIGS. 4 and 5, the embodiments are not limited thereto, and the feature extractor module 222 may extract various static feature data not illustrated in FIG. 4 from information about a neural network model and information about a hardware device that are not affected by the execution environment of the neural network model, and may also extract various dynamic feature data not illustrated in FIG. 5 from information about a neural network model and information about a hardware device that may vary depending on the execution environment of the model.

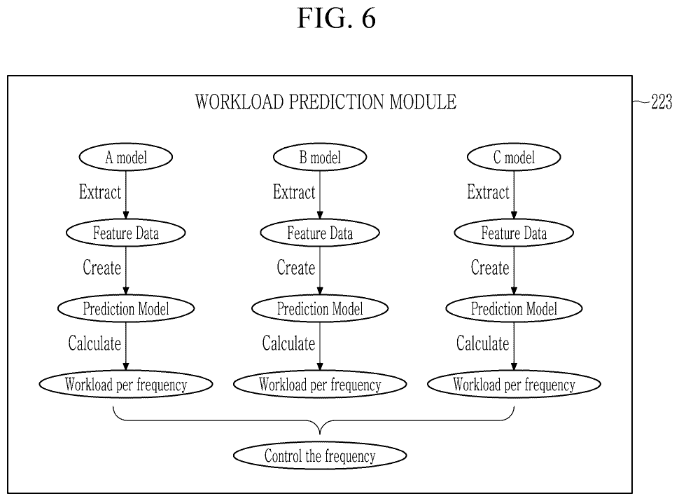

FIG. 6 illustrates a workload prediction module according to at least one embodiment of the present disclosure shown in FIG. 2.

Referring to FIG. 6, the workload prediction module 223 may create a prediction model based on extracted static feature data and dynamic feature data. When a plurality of neural network models is to be executed, the workload prediction module 223 may create a prediction model for each of the plurality of neural network models. For example, if the neural network models to be executed include model A, model B, and model C, the workload prediction module 223 may create a prediction model for neural network model A, a prediction model for neural network model B, and a prediction model for neural network model C, respectively.

The workload prediction module 223 may create a prediction model by constructing a function represented by a scaling factor with extracted static feature data and dynamic feature data. For example, the function of the prediction model may be represented as the following equation.

$$f ( {f}_{NPU} , {f}_{DMA} , {f}_{DRAM} ) = Workload per frequency = {s}_{0} \cdot g ( {f}_{NPU} ) + {s}_{1} \cdot h ( {f}_{DMA} , {f}_{DRAM} ) \qquad ( Equation 1 )$$

Here, f_{NPU}, f_{DMA}, and f_{DRAM} represent the operating frequency of the NPU, the operating frequency of the DMA, and the operating frequency of the DRAM, respectively, and S₀ and S₁ represent scaling factors. Additionally, g(f_{NPU}) and h(f_{DMA}, f_{DRAM}) may be represented by the following equation.

$$g ( {f}_{NPU} ) = \frac{{W}_{MAC}}{{f}_{NPU}} \cdot ( 1 - {P}_{idle} ) \qquad ( Equation 2 )$$

$$h ( {f}_{DMA} , {f}_{DRAM} ) = \frac{{W}_{DMA}}{{f}_{DMA} \cdot α} \cdot {P}_{idle} \qquad ( Equation 3 )$$

Here, P_{idle} represents idle time ratio of the NPU MAC engine with a value between 0 and 1 at a specific frequency, W_{MAC} represents the amount of MAC computation of the corresponding neural network model, and W_{DMA} represents the amount of data transferred from the DRAM to the NPU MAC engine through DMA. Additionally, a represents a correction value for the DMA speed according to the operating frequency of the DRAM.

The value of f(f_{NPU}, f_{DMA}, f_{DRAM}) in the Equation 1 described above may have a value of workload per frequency. The workload prediction module 223 may calculate the values of scaling factors S₀ and S₁ based on static feature data of a specific neural network model, such as W_{MAC} and W_{DMA}, dynamic feature data of the corresponding neural network model, such as P_{idle}, which may be acquired according to execution of the corresponding neural network model, and values of f_{NPU}, f_{DMA}, and f_{DRAM}, which are operating frequencies of hardware devices when executing the corresponding neural network model. At this time, the values of S₀ and S₁ may be calculated through a regression algorithm.

That is, the value of the scaling factor may be calculated through the data acquired by executing a specific neural network model a predetermined number of times, and the workload prediction module 223 may predict the magnitude of the operating frequency based on the prediction model function.

For example, the workload prediction module 223 may predict a workload having a value that satisfies the condition that the prediction model function value of Equation 1 has a value less than or equal to an execution deadline of the neural network model to be executed, and may predict the operating frequency of the hardware device based on the predicted workload.

In addition, when a plurality of neural network models is to be executed, the workload prediction module 223 may build a prediction model function for each of the plurality of neural network models as described above. Since feature data such as the amount of MAC computation for each neural network model may be different from each other, the scaling factor of each prediction model function may have different values, but the embodiment is not necessarily limited thereto.

Although the prediction model function of the workload prediction module 223 in Equations 1 to 3 has been described as predicting the operating frequency of the hardware device using only the amount of MAC computation for executing the corresponding neural network model, the amount of data transmission for executing the corresponding neural network model, the idle portion of the NPU MAC core, and the deadline of the corresponding neural network model, this is only for ease of description and the embodiments are not limited thereto, and the prediction model function may predict the operating frequency of the hardware device additionally based on various feature data described in FIGS. 4 and 5.

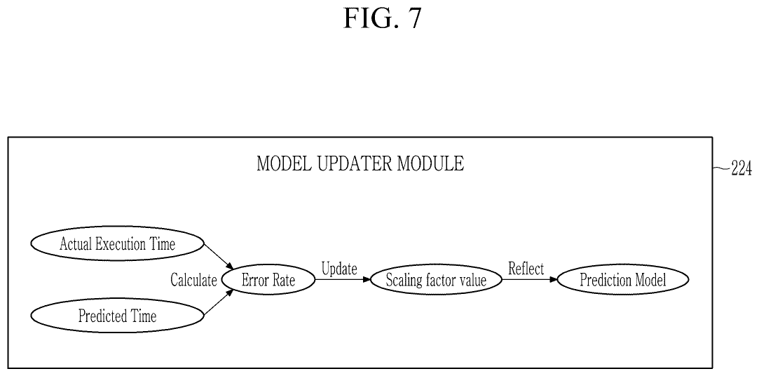

FIG. 7 illustrates a model updater module according to at least one embodiment of the present disclosure shown in FIG. 2.

Referring to FIG. 7, the model updater module 224 may update the scaling factor value represented by the prediction model function of the workload prediction module 223 based on the execution result of the neural network model.

Specifically, when the execution of the neural network model is terminated at the operating frequency predicted by the workload prediction module 223, the model updater module 224 may receive the actual execution time of the neural network model. The model updater module 224 may determine an error rate between the predicted execution time of the corresponding neural network model according to the predicted operating frequency and the actual execution time of the corresponding neural network model, e.g., by comparing the predicted execution time and the actual execution time.

The model updater module 224 may redetermine and update the scaling factor value represented by the prediction model function for the corresponding neural network model when the calculated error rate is greater than or equal to a predetermined threshold value (e.g., ±10%). The model updater module 224 may reflect the updated scaling factor to the prediction model for the corresponding neural network model.

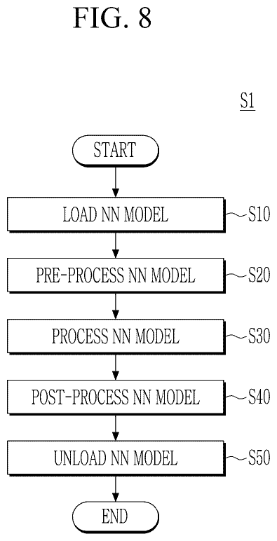

FIG. 8 is a flowchart illustrating a frequency control method for the neural processing unit according to at least one embodiment of the present disclosure.

Referring to FIG. 8, a frequency control method for a neural processing unit S1 may include a step of loading a neural network model S10. For example, when an execution request for a specific neural network model is received from a user (e.g., CPU), the model manager module (221 in FIG. 2) may store information about the corresponding neural network model in the form of a table.

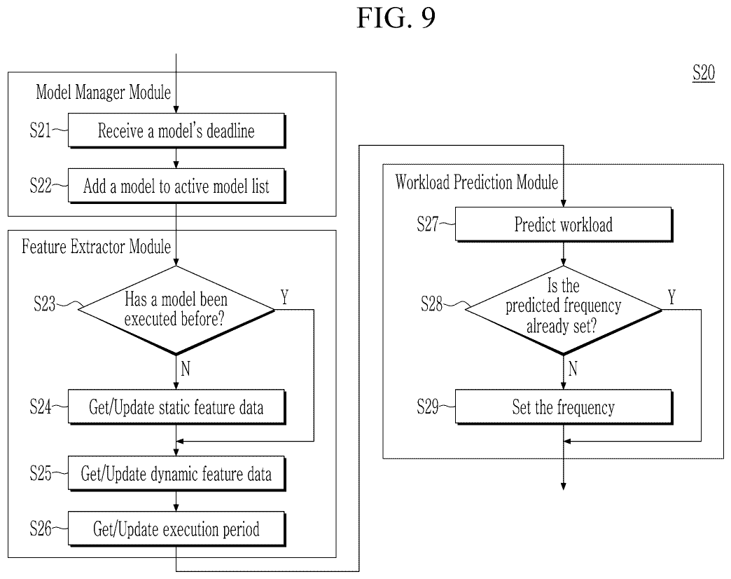

The frequency control method for the neural processing unit S1 may include a step of pre-processing a neural network model S20. The step of pre-processing the neural network model (S20) may be performed from the time of receiving an execution command for the corresponding neural network model from a user (e.g., CPU) before executing the neural network model. The step of pre-processing the neural network model (S20) is described later with reference to FIG. 9.

The frequency control method for the neural processing unit S1 may include a step of processing a neural network model S30. For example, based on the operating frequency predicted by the workload prediction module (223 in FIG. 2), the hardware device may execute the corresponding neural network model.

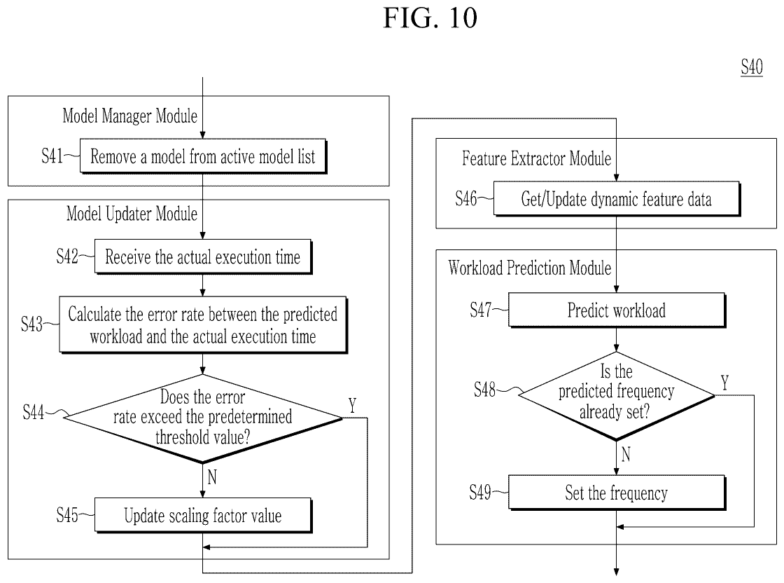

The frequency control method for the neural processing unit S1 may include a step of post-processing a neural network model S40. The step of post-processing the neural network model S40 may be performed from the time when execution of the neural network model ends before receiving a termination command of the frequency control system (1 in FIG. 1) from a user and/or a host device (e.g., CPU). The step of post-processing the neural network model S40 is described later with reference to FIG. 10.

The frequency control method for the neural processing unit S1 may include a step of unloading a neural network model S50. For example, when a termination command of the frequency control system (1 in FIG. 1) is received from a user and/or host device (e.g., CPU), the model manager module (221 in FIG. 2) may unload the corresponding neural network model.

FIG. 9 is a flowchart illustrating a pre-processing operation of a neural network model of the frequency control method for the neural processing unit according to at least one embodiment of the present disclosure shown in FIG. 8.

Referring to FIG. 9, the step of pre-processing the neural network model (S20) may include a step of receiving an execution deadline for a neural network model requested to be executed (S21). For example, the model manager module (221 in FIG. 2) may receive information from a user (e.g., CPU) about a deadline by which the neural network model should be executed.

The step of pre-processing the neural network model (S20) may include a step of adding a neural network model to be executed to an active model list (S22). For example, the model manager module (221 in FIG. 2) may add a neural network model to be executed to an execution queue.

The step of pre-processing the neural network model (S20) may include a step of determining whether a neural network model to be executed has been executed before (S23). For example, the feature extractor module (222 of FIG. 2) may determine whether the neural network model to be executed has been executed before based on information about the neural network model registered in the model manager module (221 of FIG. 2).

If the neural network model to be executed has not been executed before (N of S23), the step of pre-processing the neural network model (S20) may include a step of acquiring/updating static feature data for a neural network model to be executed (S24). For example, the feature extractor module (222 in FIG. 2) may acquire static feature data about the corresponding neural network model based on information about the neural network model registered in the model manager module (221 in FIG. 2).

If the neural network model to be executed has been executed before (Y of S23), static information about the neural network model is registered in the model manager module (221 of FIG. 2) based on the previous execution result data of the neural network model, and therefore, the feature extractor module (222 of FIG. 2) may extract static feature data about the corresponding neural network model based on the static information.

The step of pre-processing the neural network model (S20) may include a step of acquiring/updating dynamic feature data (S25). For example, the feature extractor module (222 in FIG. 2) may extract dynamic feature data about the corresponding neural network model based on information about the neural network model and information according to the real-time execution environment of the hardware device.

The step of pre-processing the neural network model (S20) may include a step of acquiring/updating an execution request period of the corresponding neural network model (S26). For example, the feature extractor module (222 in FIG. 2) may acquire/update the execution request period of the model and transfer the execution request period to the workload prediction module (223 in FIG. 2).

The step of pre-processing the neural network model (S20) may include a step of predicting a workload of a neural network model to be executed (S27). For example, the workload prediction module (223 in FIG. 2) may predict a workload that satisfies the execution deadline condition of the corresponding neural network model as described with reference to FIG. 6.

The step of pre-processing the neural network model (S20) may include a step of determining whether the predicted operating frequency is already set for a neural network model to be executed (S28). For example, the workload prediction module (223 in FIG. 2) may determine whether the corresponding neural network model has been executed in the same hardware execution environment based on information about the neural network model registered in the model manager module (221 in FIG. 2) and information about the hardware real-time execution environment, and may determine whether the predicted operating frequency for the neural network model to be executed has already been set.

If the predicted operating frequency for the neural network model to be executed has not been set (N of S28), the step of pre-processing the neural network model (S20) may include a step of setting the operating frequency of the hardware device for the neural network model to be executed (S29). For example, the workload prediction module (223 in FIG. 2) may predict the magnitude of the operating frequency of the hardware device based on the predicted workload as described with reference to FIG. 6.

In addition, the workload prediction module (223 in FIG. 2) may determine the setting point of the corresponding operating frequency based on the execution request period of the corresponding neural network model received from the feature extractor module (222 in FIG. 2). For example, if the execution request period of the neural network model is X, the workload prediction module (223 in FIG. 2) may determine that the corresponding operating frequency is set at least at a point corresponding to the period X.

If a predicted operating frequency is set for the neural network model to be executed (Y of S28), the previous execution operating frequency for the neural network model may be determined as the current execution operating frequency.

The workload prediction module (223 in FIG. 2) may control the operating frequency of a hardware device by predicting and determining the magnitude of the operating frequency and the setting point of the operating frequency as described above.

FIG. 10 is a flowchart illustrating a post-processing operation of a neural network model of the frequency control method for the neural processing unit according to at least one embodiment of the present disclosure shown in FIG. 8.

Referring to FIG. 10, the step of post-processing a neural network model (S40) may include a step of removing a neural network model whose execution has ended from the active model list (S41). For example, the model manager module (221 in FIG. 2) may remove a neural network model whose execution has ended from the execution queue.

The step of post-processing a neural network model (S40) may include a step of receiving the actual execution time of the neural network model whose execution has ended (S42). For example, the model updater module (224 in FIG. 2) may receive information about the actual execution time of the neural network model whose execution has ended.

The step of post-processing a neural network model (S40) may include a step of calculating an error rate between the predicted workload and the actual execution time (S43). For example, the model updater module (224 in FIG. 2) may calculate an error rate between the predicted execution time and the actual execution time based on the predicted workload and the predicted operating frequency.

The step of post-processing a neural network model (S40) may include a step of determining whether the calculated error rate exceeds a predetermined value (S44). The model updater module (224 in FIG. 2) may determine whether the calculated error rate exceeds, for example, ±10%.

If the calculated error rate exceeds the predetermined value (Y of S44), the step of post-processing the neural network model (S40) may include a step of updating a scaling factor value (S45). For example, the model updater module (224 in FIG. 2) may update a scaling factor value through a regression algorithm based on information about the execution result for the executed neural network model (e.g., the operating frequency of the hardware device, the amount of MAC computation, the amount of data transmission, etc. represented by Equations 1 to 3) and information about the previous execution result. If the calculated error rate is less than the predetermined value (N in S44), the scaling factor value may not be updated.

The step of post-processing a neural network model (S40) may include a step of acquiring/updating dynamic feature data (S46). For example, the feature extractor module (222 in FIG. 2) may acquire/update dynamic feature data regarding neural network models to be executed subsequent to the neural network model whose execution has ended.

For example, when the first neural network model is terminated and the second neural network model is subsequently executed, the feature extractor module (222 in FIG. 2) may obtain/update dynamic feature data only for the second neural network model.

The step of post-processing a neural network model (S40) may include a step of predicting the workload of the neural network model to be executed subsequently (S47). For example, the workload prediction module (223 in FIG. 2) may predict a workload that satisfies the execution deadline condition of the corresponding neural network model as described with reference to FIG. 6.

The step of post-processing a neural network model (S40) may include a step of determining whether a predicted operating frequency for a neural network model to be subsequently executed is already set (S48). For example, the workload prediction module (223 in FIG. 2) may determine whether the corresponding neural network model has been executed in the same hardware execution environment based on information about the neural network model registered in the model manager module (221 in FIG. 2) and information about the hardware real-time execution environment, and may determine whether the predicted operating frequency for the neural network model to be executed has already been set.

If the predicted operating frequency for the neural network model to be executed has not been set (N of S28), the step of post-processing a neural network model (S40) may include a step of setting the operating frequency of the hardware device for the neural network model to be executed (S49). For example, the workload prediction module (223 in FIG. 2) may predict the size of the operating frequency of the hardware device based on the predicted workload as described with reference to FIG. 6 and the dynamic feature data updated in step S46.

If a predicted operating frequency is set for the neural network model to be executed (Y of S48), the previous execution operating frequency for the neural network model may be determined as the current execution operating frequency.

FIG. 11 illustrates a mobile device to which a frequency control system for a neural processing unit according to at least one embodiment of the present disclosure is applied.

Referring to FIG. 11, a mobile device 1000 may include a camera 1100, a display 1200, an audio 1300, a modem 1400, dynamic random-access memories (DRAMs) 1500a and 2500b, flash memory devices 1600a and 1600b, I/O devices 1700a and 1700b, and an application processor (AP) 1800.

The mobile device 1000 may be implemented by a smartphone, a laptop computer, a portable terminal, a tablet PC, a wearable device, a healthcare device, an Internet-of-Things (IoT) device, etc. Additionally, the mobile device 1000 may be implemented by a server or a personal computer.

The camera 1100 may be configured to capture a still image or a video according to user control. The mobile device 1000 may obtain specific information using a still image/video captured by the camera 1100 or may convert the still image/video into other types of data such as text, and store the converted data. Alternatively, the mobile device 1000 may recognize a character string included in a still image/video captured by the camera 1100 and provide a text or audio translation corresponding to the character string. As such, the field of use of the camera 1100 in the mobile device 1000 is increasingly diversified. In at least one embodiment, the camera 1100 may transmit data such as a still image/video to the AP 1800 according to a D-Phy or C-Phy interface based on the MIPI standard.

The display 1200 may be configured to display an image and/or text, and may be implemented in various forms such as a liquid crystal display (LCD), an organic light emitting diode (OLED) display, active-matrix organic light emitting diode (AM-OLED), plasma display panel (PDP), field emission display (FED), or electronic paper. In at least one embodiment, the display 1200 may also be used as an input device of the mobile device 1000 by providing a touch screen function. Additionally, the display 1200 may be provided integrally with a fingerprint sensor or the like to provide a security function of the mobile device 1000. In at least one embodiment, the AP 1800 may transmit image data to the display 1200 to be displayed on the display 1200 according to a D-Phy or C-Phy interface based on the MIPI standard.

The audio 1300 may be configured to process audio data stored in the flash memory devices 1600a and 1600b or audio data included in contents received externally through the modem 1400 or the I/O devices 1700a and 1700b. For example, the audio 1300 may perform various processes such as coding/decoding, amplification, and noise filtering for audio data.

The modem 1400 may be configured to modulate and transmit signals to transmit/receive wired/wireless data, while demodulating signals received from outside to restore the original signal. The I/O devices 1700a and 1700b are devices that provide digital input and output, and may include a port that may be connected to an external recording medium, input devices such as touch screens or mechanical button keys, output devices capable of outputting vibrations in a haptic way, and the like. In some embodiments, the I/O devices 1700a and 1700b may be connected to an external recording medium through ports such as USB, lightning cable, SD card, micro SD card, DVD, network adapter, or the like.

The AP 1800 may control the overall operation of the mobile device 1000. In detail, the AP 1800 may control the display 1200 such that a portion of the content stored in the flash memory devices 1600a and 1600b is displayed on the screen. In addition, when user input is received through the I/O devices 1700a and 1700b, the AP 1800 may perform a control operation corresponding to the user input.

The AP 1800 may be provided as a system-on-chip (SoC) driving an application program, an operating system (OS), and/or the like. Additionally, the AP 1800 may be included in one semiconductor package with other devices included in the mobile device 1000—for example, the DRAM 1500a, a flash memory 1620, and/or a memory controller 1610. For example, in the form of a package such as package on package (POP), ball grid arrays (BGAs), chip scale packages (CSPs), system in package (SIP), multi-chip package (MCP), wafer-level fabricated package (WFP), wafer-level processed stack package (WSP) or the like, at least one device other than the AP 1800 may be provided. The kernel of the operating system running on the AP 1800 may include an I/O scheduler and device drivers for controlling the flash memory devices 1600a and 1600b. The device driver may control the access performance of the flash memory devices 1600a and 1600b by referring to the number of synchronous queues managed by the I/O scheduler, or may control the CPU mode, DVFS level, etc. inside the SoC.

In at least one embodiment, the AP 1800 may include a processor block that executes an operation or drives an application program and/or an operating system, and various other peripheral components connected through the processor block and the system bus. Peripheral components may include a memory controller, an internal memory, a power management block, an error detection block, and a monitoring block. The processor block may include one or more cores, and when a plurality of cores is included in the processor block, each of the cores includes a cache memory, and a common cache shared by the cores may be included in the processor block.

In at least one embodiment, the AP 1800 may include an accelerator block 1820, which is a dedicated circuit for AI data operation. Alternatively, in some embodiments, a separate accelerator chip may be provided separately from the AP 1800, and the DRAM 1500b may be additionally connected to the accelerator block 1820 or the accelerator chip. The accelerator block 1820 is a function block that specializes in executing specific functions of the AP 1800, and includes a graphics processing unit (GPU) that is a functional block that specializes in executing graphic data processing, a neural processing unit (NPU) which is a block for professionally executing AI calculation and inference, and a data processing unit (DPU) that is a block that specializes in data transmission.

According to at least one embodiment, the mobile device 1000 may include a plurality of DRAMs 1500a and 1500b. In at least one embodiment, the AP 1800 may include a controller 1810 for controlling the DRAMs 1500a and 1500b, and the DRAM 1500a may be directly connected to the AP 1800.

The AP 1800 controls DRAM by setting commands and mode register sets (MRS) conforming to JEDEC standard specifications, or may communicate by establishing specifications and functions such as low-voltage/high-speed/reliability required by the mobile device 1000 and DRAM interface protocol for CRC/ECC. For example, the AP 1800 may communicate with the DRAM 1500a through an interface conforming to JEDEC standard specifications such as LPDDR4 and LPDDR5. Alternatively, the AP 1800 may set a new DRAM interface protocol to control the DRAM 1500b for the accelerator in which the accelerator chip provided separately from the accelerator block 1820 or the AP 1800 has a higher bandwidth than the DRAM 1500a.

Although only DRAMs 1500a and 1500b are illustrated in FIG. 11, the configuration of the mobile device 1000 is not necessarily limited to this type. For example, depending on the bandwidth, response speed, and voltage conditions of the AP 1800 or the accelerator block 1820, other memories rather than the DRAMs 1500a and 1500b may also be included in the mobile device 1000. For example, the controller 1810 and/or the accelerator block 1820 may control various memories such as PRAM, SRAM, MRAM, RRAM, FRAM, Hybrid RAM, and/or the like. The DRAMs 1500a and 1500b have relatively low latency and high bandwidth than the I/O devices 1700a and 1700b or the flash memory devices 1600a and 1600b. The DRAMs 1500a and 1500b may be initialized at the power-on time point of the mobile device 1000, and when the operating system and application data are loaded, the DRAMs 1500a and 1500b may be used as temporary storage locations for the operating system and application data or as execution spaces for various software codes.

Addition/subtraction/multiplication/dividing arithmetic operations and vector operations, address operations, or fast Fourier transform (FFT) operations data may be stored in the DRAMs 1500a and 1500b. In another embodiment, the DRAMs 1500a and 1500b may be provided as processing-in-memory (PIM) equipped with a calculation function. For example, a function for executing a function used for inference in the DRAMs 1500a and 1500b may be executed. In this case, the inference may be performed in a deep learning algorithm using an artificial neural network. The deep learning algorithm may include a training operation of training a model through various data and an inference operation of recognizing data with the trained model. For example, the function used for the inference may include a hyperbolic tangent function, a sigmoid function, and a rectified linear unit (ReLU) function.

As at least one embodiment, an image captured by the user through the camera 1100 may be signal-processed and stored in the DRAM 1500b, and the accelerator block 1820 or accelerator chip may execute AI data operations of recognizing data using data stored in the DRAM 1500b and the function used for inference.

According to at least one embodiment, the mobile device 1000 may include a plurality of storage or a plurality of flash memory devices 1600a and 1600b having a larger capacity than the DRAMs 1500a and 1500b. The flash memory devices 1600a and 1600b may include the memory controller 1610 and the flash memory 1620. The memory controller 1610 receives control commands and data from the AP 1800, writes data to the flash memory 1620 in response to the control command, or reads data stored in the flash memory 1620 to access the AP 1800 and may transmit the data to the AP 1800.

According to at least one embodiment, the accelerator block 1820 or the accelerator chip may execute training operations and AI data calculation using the flash memory devices 1600a and 1600b. In at least one embodiment, operation logic capable of executing a predetermined operation inside the flash memory devices 1600a and 1600b may be implemented in the memory controller 1610, and the operation logic may execute at least a portion of the training operations and the operation of the inference AI data executed by the AP 1800 and/or the accelerator block 1820, using the data stored in the flash memory 1620 instead.

In at least one embodiment, the AP 1800 may include an interface 1830, and accordingly, the flash memory devices 1600a and 1600b may be directly connected to the AP 1800. For example, the AP 1800 may be implemented as an SoC, the flash memory device 1600a may be implemented as a separate chip from the AP 1800, and the AP 1800 and the flash memory device 1600a may be mounted in one package. However, the example embodiments are not limited thereto, and a plurality of flash memory devices 1600a and 1600b may be electrically connected to the mobile device 1000 through a connection.

The flash memory devices 1600a and 1600b may store data such as still images/movies taken by the camera 1100, or may store data received through a communication network and/or ports included in the I/O devices 1700a and 1700b. For example, the flash memory devices 1600a and 1600b may store augmented reality/virtual reality, high-definition (HD), or ultra-high-definition (UHD) contents.

According to at least one embodiment of the present disclosure, the AP 1800 may drive a camera application that abstracts the camera 1100 and allows the user to use the camera 1100. The AP 1800 may drive a neural network model that detects an object in an image frame generated by the camera application, a neural network model that determines what the object is, etc., while the camera application is being executed.

According to at least one embodiment of the present disclosure, the AP 1800 may extract static feature data and dynamic feature data based on information about each of various neural network models and information about hardware devices. Additionally, the AP 1800 may predict and control the operating frequency of each hardware device for executing a neural network model based on the extracted static feature data and dynamic feature data. That is, the mobile device 1000 may reduce the amount of power consumed by the hardware device by setting the optimal operating frequency at an appropriate time while complying with the target execution time by considering the characteristics of each neural network model in real time.

While the embodiments of the present disclosure have been described in detail, it is to be understood that the disclosure is not limited to the disclosed embodiments, but on the contrary, is intended to cover various modifications and equivalent arrangements included within the spirit and scope of the appended claims.

What is claimed is:

1. A frequency control method for a neural processing unit (NPU), comprising:
receiving information about a neural network model to be executed on the NPU;
extracting static feature data determined within offline time of the neural network model and dynamic feature data determined within a runtime of the neural network model from information about the NPU and the information about the neural network model;
generating a prediction model based on the static feature data and the dynamic feature data such that the prediction model is configured to predict an operating frequency of the NPU executing the neural network model; and
controlling the operating frequency of the NPU based on the prediction model.

2. The frequency control method for the neural processing unit of claim 1, wherein the static feature data includes at least one of an amount of multiply-accumulate (MAC) computation of the NPU to be applied in the execution of the neural network model, an amount of data to be transmitted to the NPU in the execution of the neural network model, or an instruction size of the neural network model.

3. The frequency control method for the neural processing unit of claim 1, wherein the dynamic feature data includes at least one of an execution time of the neural network model, an execution request period of the neural network model, an execution deadline of the neural network model, an execution priority of the neural network model, an idle time ratio of at least one NPU core during execution of the neural network model, a current execution level of the neural network model, a list of the neural network models requested for execution, or a bandwidth of a memory used for execution of the neural network model.

4. The frequency control method for the neural processing unit of claim 1, further comprising:
storing the information about the neural network model in a form of a table.

5. The frequency control method for the neural processing unit of claim 4, wherein the information about the neural network model stored in the table includes at least one of an identification of the neural network model, an amount of multiply-accumulate (MAC) computation of the NPU to be applied in the execution of the neural network model, an amount of data to be transmitted to the NPU in the execution of the neural network model, an execution deadline of the neural network model, or an execution request period of the neural network model.

6. The frequency control method for the neural processing unit of claim 1, further comprising:
determining whether the neural network model has been previously executed,
wherein, when the neural network model has been determined to have been previously executed, the extracting the static feature data and the dynamic feature data comprises extracting the static feature data based on previous execution result data.

7. The frequency control method for the neural processing unit of claim 1, wherein
the neural network model comprises a first neural network model and a second neural network model executed subsequent to the first neural network model; and
generating the prediction model comprises
generating a first prediction model for the first neural network mode; and
generating a second prediction model for the second neural network model.

8. The frequency control method for the neural processing unit of claim 7, wherein controlling the operating frequency of the NPU comprises
predicting a workload for the first neural network model; and
setting an operating frequency of the NPU based on the dynamic feature data of the first neural network model and the predicted workload for the first neural network model.

9. The frequency control method for the neural processing unit of claim 8, wherein controlling the operating frequency of the NPU further comprises
updating dynamic feature data regarding the second neural network model after the execution of the first neural network model is terminated.

10. The frequency control method for the neural processing unit of claim 9, wherein
controlling the operating frequency of the NPU further comprises
predicting a workload for the second neural network model; and
setting the operating frequency of the NPU based on the updated dynamic feature data of the second neural network model and the predicted workload for the second neural network model.

11. The frequency control method for the neural processing unit of claim 3, wherein controlling the operating frequency of the NPU comprises
determining a magnitude of the operating frequency of the NPU; and
determining a setting point of the operating frequency of the NPU based on the determined magnitude.

12. The frequency control method for the neural processing unit of claim 11, wherein the setting point of the operating frequency of the NPU is determined based on at least the execution request period of the neural network model.

13. The frequency control method for the neural processing unit of claim 1, further comprising:
adding a neural network model to an active model list before executing the neural network model; and
removing the neural network model from the active model list when execution of the neural network model is terminated.

14. The frequency control method for the neural processing unit of claim 1, wherein generating the prediction model comprises
constructing a function with the static feature data and the dynamic feature data, the function represented by a scaling factor.

15. The frequency control method for the neural processing unit of claim 14, wherein the scaling factor value is determined based on a regression algorithm.

16. The frequency control method for the neural processing unit of claim 14, further comprising:
determining an error rate based on a comparison of a predicted execution time of the neural network model, according to the operating frequency of the NPU predicted by the predicted model, and the actual execution time of the neural network model; and
updating a function scaling factor value of the prediction model when the error rate is greater than or equal to a tolerance value.

17. A frequency control method for a neural processing unit (NPU), comprising:
storing information about a neural network model to be executed on the NPU;
extracting static feature data determined within offline time of the neural network model and dynamic feature data determined within runtime of the neural network model from the information about the neural network model;
predicting a magnitude of an operating frequency and a setting point of the operating frequency for executing the neural network model by constructing a function based on the static feature data and the dynamic feature data, the function represented by a scaling factor; and
updating a value of the scaling factor based on a result of the execution of the neural network model.

18. The frequency control method for the neural processing unit of claim 17, further comprising:
controlling the operating frequency of the NPU based on the predicted magnitude of the operating frequency and the predicted setting point of the operating frequency.

19. A frequency control system for a neural processing unit (NPU), comprising:
a NPU controller;
an NPU multiply-accumulate (MAC) operator configured to perform MAC operations on a neural network model;
a memory configured to receive and buffer information about the neural network model;
an NPU direct memory access (NPU DMA) configured to control input/output of information about the neural network model between the NPU controller and the memory; and
a system bus configured to support communication between the NPU controller and the memory,
wherein the NPU controller is configured to
store information about the neural network model,
extract static feature data determined within offline time of the neural network model and dynamic feature data determined within runtime of the neural network model from the information about the neural network model,
predict a magnitude of an operating frequency and a setting point of the operating frequency for executing the neural network model by constructing a function based on the static feature data and the dynamic feature data, the function represented by a scaling factor, and
update a value of the scaling factor based on a result of the execution of the neural network model.

20. The frequency control system for the neural processing unit of claim 19, wherein the NPU controller is configured to control the operating frequency of the NPU MAC operator based on the predicted magnitude of the operating frequency and the predicted setting point of the operating frequency.
